(19) United States
(12) Patent Application Publication
(10) Pub. No.: US 2020/0036563 A1
(43) Pub. Date: Jan. 30, 2020

(54) PASSIVE CONTINUOUS-TIME LINEAR EQUALIZER

(71) Applicant: ADVANCED MICRO DEVICES, INC., Santa Clara, CA (US)

(72) Inventors: Gerald R. TALBOT, Boxborough, MA (US); Dean GONZALES, Fort Collins, CO (US)

(21) Appl. No.: 16/215,324

(22) Filed: Dec. 10, 2018

Related U.S. Application Data
(60) Provisional application No. 62/703,685, filed on Jul. 26, 2018.

(51) Int. Cl. H04L 25/03; H02H 9/04

(52) U.S. Cl. CPC H04L 25/03031; H04L 25/03159; H02H 9/045

(57) ABSTRACT

A passive continuous time linear equalizer (CTLE) includes an alternating current (AC) coupling capacitor coupled in series between an input node and an output node of the passive equalizer. An electrostatic discharge protection device is coupled in parallel to the input node. An inductor is coupled in parallel to a node between the input node and the output node. Further, the passive CTLE includes a variable resistor coupled in series between the inductor and a ground. Increased impedance of the inductor at higher frequencies portions of the input signal operate to boost a gain of the equalizer at the higher frequencies without active power by over-terminating the input signal.

### CROSS REFERENCE TO RELATED APPLICATIONS

This application claims priority to U.S. Provisional Patent Application 62/703,685, entitled “PASSIVE CONTINUOUS-TIME LINEAR EQUALIZER” and filed on Jul. 31, 2018, the entirety of which is incorporated by reference herein.

### BACKGROUND

Due to increasing demand for signal equalization in electronics, there has been an increasing interest in equalization schemes that are able to recover signals which have been degraded by physical losses in a channel. This conditioning of digital signals is often referred to as emphasis in the transmit domain and equalization in the receive domain. Continuous time linear equalization is part of the signal conditioning ecosystem designed to aid in the transmission and reception of high-speed digital signals.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an apparatus including a passive continuous-time linear equalizer (CTLE) in accordance with some embodiments.

FIG. 2 is diagram illustrating an eye diagram at an output of the passive CTLE of FIG. 1 in accordance with some embodiments.

FIG. 3 is a diagram illustrating simulated frequency responses for the passive CTLE of FIG. 1 in accordance with some embodiments.

FIG. 4 shows an apparatus in the form of a system implementing the passive CTLE of FIG. 1 in accordance with some embodiments.

### DETAILED DESCRIPTION

Many electronic devices or systems, such as computers, tablets, digital televisions, include components (e.g., integrated circuit chips) that communicate with each other using signals that carry data. The signals are often transmitted on conductive lines, such as metal-based traces, on circuit boards. Some electrical components communicate with each other using relatively high frequency signals and such high frequency signals may be used to transmit data at relatively high data rates. Some conventional receiver components may be able to receive data at such a high data rate. However, such conventional receiver components often suffer from a steep cost in power consumption and area.

Further, received signals often suffer from inter-symbol interference (ISI) due to channel imperfections such as reflection, crosstalk and limited bandwidth. At the transmitter side, transmitters can use fractionally spaced feed-forward equalizers (FFE) to cancel both pre-cursor and post-cursor ISI. At the receiver side, as high-speed signals pass through transmission media, high-frequency signal components are quickly attenuated due to physical properties of the conductive lines and the surrounding dielectric. The high-speed signal in a receiver experiences loss through the channel, the package, and the silicon interposer, with ISI problems increasing along with high data rates. To complicate the problem, ISI can change over time due to different data patterns, and with such varying conditions as bending, vibrations, and process, voltage and temperature (PVT) variations, thereby degrading performance.

To mitigate ISI, various equalization strategies such as use of FFEs, continuous-time linear equalizers (CTLEs) and decision feedback equalizers (DFEs) have been employed at the transmitter and/or the receiver for high-speed serial communications to restore balance between various frequency components which together make up an electronic signal. CTLEs, in combination with digital equalization strategies like decision feedback equalization, enable robust signal reception across media with levels of signal attenuation not possible with DFE alone.

CTLEs combat pre-cursors and post-cursors by amplifying high-frequency components around the Nyquist frequency of transmitted data. A CTLE often includes a linear filter applied at the receiver that amplifies components around the Nyquist frequency and filters off higher frequencies. CTLE gain can be adjusted to optimize the ratio of low frequency attenuation to high frequency amplification. The linear gain or high-pass boost by CTLE circuitry helps to expand an incoming signal envelope. However, traditional passive CTLEs typically operate as a high pass filter that attenuates low frequency signal components.

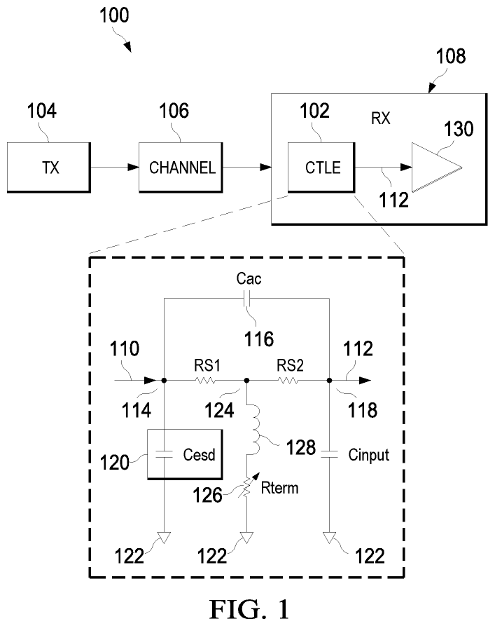

In high-speed signaling, the signal received at the receiver includes spectrally rich data patterns with the frequency content complex from DC through the Nyquist frequency of the data rate. Accordingly, attenuation of low frequency signal components results in loss of signal data. To improve equalization performance, FIGS. 1-4 illustrate an example of a passive CTLE that over-terminates an input signal to provide an equalizing high-frequency boost to higher-frequency signal components without active power and without attenuating lower-frequency signal components. In various embodiments, the passive CTLE includes an alternating current (AC) coupling capacitor coupled in series between an input node and an output node of the passive equalizer. An electrostatic discharge protection device coupled in parallel to the input node. An inductor coupled in parallel to a node between the input node and the output node. Further, the passive CTLE includes a variable resistor coupled in series between the inductor and a ground. Increased impedance of the inductor at higher frequencies portions of the input signal operate to boost a gain of the equalizer at the higher frequencies without active power by over-terminating the input signal.

FIG. 1 is a diagram illustrating an apparatus 100 including a passive continuous-time linear equalizer (CTLE) 102 according to some embodiments. As shown, the apparatus 100 includes a transmitter (TX) 104, one or more channels 106, and a receiver (RX) 108. In various embodiments, the apparatus 100 is included in an electronic device or system, such as a computer (e.g., server, desktop, laptop, or notebook), a tablet, a mobile device, or other electronic devices or systems. In some embodiments, the TX 104 is formed on a first integrated circuit while the RX 108 is formed on a second integrated circuit, and the first and second integrated circuits are mounted on a printed circuit board (PCB). In other embodiments, the TX 104 and/or the RX 108 are implemented on an integrated circuit as part of a transceiver circuit.

The one or more channels 106 connect the TX 104 to the RX 108 (e.g., TX circuitry produce data that is transmitted to RX circuitry over the one or more channels 106) and conduct signals between the TX 104 and the RX 108. In various embodiments, the one or more channels 106 include any suitable physical transmission medium, including but not limited to cables and traces. Examples of transmission paths that may be used in the one or more channels 106 include conductive traces on PCBs (e.g., wirelines such as metal-based traces), differential signaling paths including conductive wires, coaxial cable paths (e.g., a CAT 5 cable), fiber optic cable paths, combinations of such paths, backplane connectors, or other suitable communications link paths.

The TX 104 transmits a signal (e.g, a data bit stream electrical signal, and the like) across the one or more channels 106 to the RX 108. In various embodiments, the TX 104 communicates with the RX 108 by transmitting signals at a relatively high frequency that correspond to a relatively high data rate. However, sending high-speed data pulses over the one or more channels 106 often result in inter-symbol interference (ISI), which limits data rates. For example, high frequency pulses propagating along the one or more channels 106 interfere with each other and lead to loss of signal. Further, at low frequencies, insertion loss from the one or more channels 106 exhibits nearly unitary gain, while significant attenuation at the Nyquist frequency (i.e., approximately equal to one-half the data rate) is observed. Accordingly, a portion of the signal energy contained from DC to the Nyquist frequency, and thus the pulse width of the pulse response is reduced.

To overcome these channel distortion effects, in various embodiments, the TX 104 and RX 108 include equalization features to reduce channel inter-symbol interference noise. For example, transmit-side equalization is sometimes implemented using feed-forward equalizers (not shown) at the TX 104. As illustrated in FIG. 1, receiver-side equalization includes implementing a passive CTLE 102 that receives an input signal 110 (such as a transmitted signal from the TX 104 with ISI) at the RX 108 and generates an equalized output 112. As described in more detail below, the RX 108 employs techniques to accurately receive data at a relatively high data rate while operating at a higher speed, consume less power, and has a smaller size in comparison to some conventional receivers. Those skilled in the art will recognize that the passive CTLE 102 may be implemented within the RX 108 in combination with other equalizer circuits or as the sole equalizer.

The one or more channel 106 typically operate as low pass filters, with the magnitudes of the low frequency components of a transmitted signal (e.g., the input signal 110 received at the passive CTLE 102 of the RX 108) generally staying the same but the high frequency components will be decreased. Equalizers function to equalize the levels between the various frequencies of the transmitted signal. The transmitted signal experiences less losses at lower frequencies due to attenuation than at higher frequencies, such that the transmitted signal exhibits roll-off with higher frequencies. Conventional passive equalizers such as passive CTLEs typically operate as high-pass filters. Accordingly, the high-pass characteristic of conventional passive CTLEs with a given cut-off frequency attenuates energy below the cut-off frequency to match the energy loss of higher frequency components, thereby resulting in signal loss. A further disadvantage of conventional passive CTLEs is that a gain stage with sufficient gain is required after equalization. The gain stage requires power to be supplied to it. Thus, a system utilizing a conventional passive CTLE has a power penalty in that it requires the input of additional power. Moreover, such a system may require extra additional components, wires, traces, or area to supply the power. The consumption of additional power generally results in poorer power efficiency and the generation of excess heat.

Accordingly, the passive CTLE 102 receives the input signal 110 at a first node 114 (also interchangeably referred to herein as the input node 114 to the passive CTLE 102). The passive CTLE 102 includes a capacitor C_{ac} 116 coupled between the first node 114 and a second node 118 that operates as an alternating current (AC) coupling capacitor to the second node 118 (also interchangeably referred to herein as the output node 118 from the passive CTLE 102). As shown, the capacitor C_{ac} 116 is a series AC coupling capacitor connecting to the second node 118. A first resistor R_{S1} and a second resistor R_{S2} are coupled in parallel to the capacitor C_{ac} 116 between the first node 114 and the second node 118. In some embodiments, the first resistor R_{S1} includes a shunt resistor and the second resistor R_{S2} includes a shunt resistor.

Electrostatic discharge (ESD) protection devices are sometimes placed in series to the on-chip signal path to protect exposed transistor pins, thus creating a complex loss parasitic to the high-speed data path. PHY designers now commonly implement on-chip transmission coils (T-coil) to shield the high-speed signal path from the ESD protection devices. For example, on a conventional front end, a T-coil (or a T-coil bridge) sometimes includes a center-tapped transformer with an ESD protection device provided at the center tap. However, adding ESD protection circuitry (such as at the center-tap of a transformer) slows signal transmission speed (e.g., operates as a capacitor such that high-frequency energy is slowed). Accordingly, to reduce the bandwidth penalty incurred due to ESD protection circuitry, the passive CTLE 102 includes an ESD protection device 120 coupled at the front end to the first node 114 in parallel to the signal path, and positioned between the first node 114 and a ground 122 tied to a ground potential.

In some embodiments, the ESD protection device 120 includes an ESD diode (not shown) to provide ESD protection for a data signal path (e.g., data transmission to and through the passive CTLE 102). The ESD protection device 120 includes a single clamping diode between an output lead and a power rail, VCC, or ground. Various types of ESD circuitry are known, and irrespective of the specific circuit configuration, the ESD protection device 120 is configured to react quickly, withstand very high voltages, and sink large currents. According to various embodiments, the ESD protection device 120 provides discharge of electrical static or charge buildup (e.g., that is over a threshold level) existing at the first node 114, through (e.g., from) the ESD protection device 120 and to ground 122, and for the sake of brevity is hereinafter represented by the effective parasitic capacitance C_{esd} of the ESD protection device 120.

Impedance of capacitors and inductors in a circuit depend on the frequency of the electric signal. The impedance of an inductor is directly proportional to frequency, while the impedance of a capacitor is inversely proportional to frequency. Capacitors placed in series with signal flow tends to pass higher-frequency (e.g., AC) portions of the signal while simultaneously blocking the lower-frequency (e.g., DC) portions of the signal. For example, the impedance offered by a capacitor can be represented by 1/(2πfC), where f is the signal frequency in Hz and C is capacitance in farads.

ESD events occur at lower frequencies relative to content signal frequencies. Accordingly, the AC coupling capacitor C_{ac} 116 placed in series to the signal flow of the passive CTLE 102 and the ESD protection device 120 is coupled in parallel to the signal flow path. The AC coupling capacitor C_{ac} 116 has a low impedance or resistance (tends to zero) for AC signals and passes higher-frequency portions of the input signal 110, thereby providing a low impedance path through the passive CTLE 102. Similarly, the AC coupling capacitor C_{ac} 116 has a high impedance or resistance (tends to infinity) for DC signals and blocks lower-frequency portions of the input signal 110. Due to the high impedance path through the AC coupling capacitor C_{ac} 116 for lower frequencies, ESD events instead pass through the ESD protection device 120 to ground 122.

The passive CTLE 102 also includes a third node 124 between the first resistor R_{S1} and a second resistor R_{S2}. A variable resistor 126 (as represented by variable resistance/impedance value Rₜₑᵣₘ) is coupled to the output from the inductor 128 and positioned in series with an inductor 128 between the third node 124 and ground 122 to provide variable termination. The inductor 128 is positioned in series between the third node 124 and the variable resistor 126. The inductive reactance (which is measured in ohms like resistance) provided by inductor 128 can be represented by X_{L}=2πfL, where f is the signal frequency in Hz and L is electrical inductance in Henrys. Accordingly, inductive reactance is directly proportional to frequency and increases with increasing frequency of the input signal 110.

At lower frequencies (e.g., close to DC), the input signal 110 experiences termination provided by the variable resistor 126. At higher frequencies, the input signal 110 experiences positive inductive reactance of the inductor 128 (e.g., the higher the frequency, the higher the impedance) added in series to the termination provided by the variable resistor 126 (e.g., Rₜₑᵣₘ), thereby over-driving (also referred to as over-terminating) the input signal 110. The additional impedance provided by the inductor 128 creates a positive gain in signal strength at higher frequencies. Accordingly, the passive CTLE 102 operates differently from conventional CTLEs for equalization operations in that the passive CTLE 102 does not attenuate low frequency portions of the input signal 110 but instead provides high frequency boosting of the input signal 110 by overdriving with the termination to compensate for undesired frequency-dependent signal loss due to the one or more channels 106 commonly experienced with high-speed links (e.g., losses in copper-based channels that exhibit undesired low-pass transfer characteristics that result in signal degradation at high data rates). In various embodiments, the passive CTLE 102 also provides positive DC boost (e.g., at the lower-frequencies of the input signal 110).

In the illustrated configuration, the input signal 110 is equalized to compensate for distortions using the passive CTLE 102, generating the equalized output signal 112. It will be appreciated that FIG. 1 includes circuit components that not only belong to the passive CTLE 102 itself but also includes circuit elements representative of other components or the effects of other components. For example, as shown in FIG. 1, the passive CTLE 102 is coupled via the output node 118 to an input buffer 130 of the RX 108. Cᵢₙₚᵤₜ represents the input (load) capacitance (e.g., due to device routing and FET gate capacitance) of the input buffer 130 (or other circuit elements) to which the passive CTLE 102 is coupled. The input buffer 130, in various embodiments, may transmit the received equalized output signal 112 from passive CTLE 102 to a next equalizer stage (not shown) or to output circuitry of the RX 108. For example, in some embodiments, the next equalizer stage(s) includes any combination of a decision feedback equalizer (DFE), a finite-impulse response (FIR) filter, and the like. However, those skilled in the art will recognize that any other suitable equalizer stages may be implemented for utilization in combination with the passive CTLE 102.

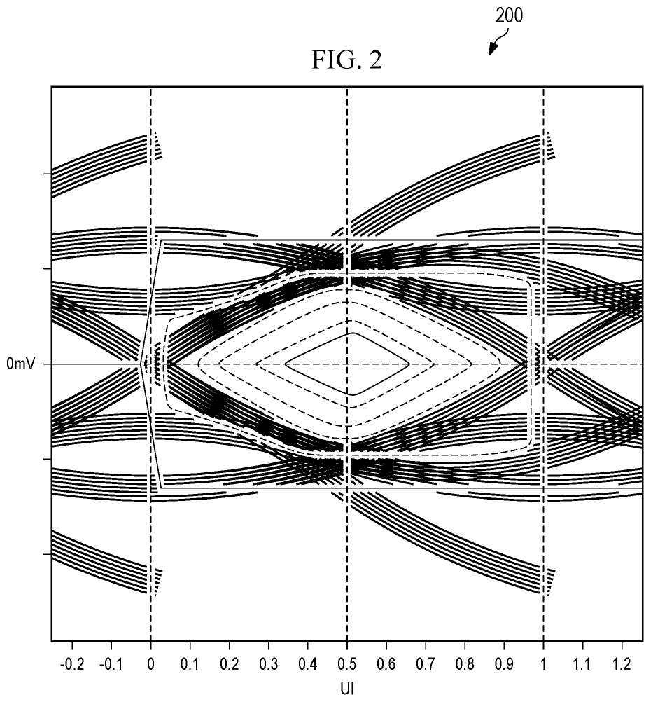

The passive CTLE 102 described herein provides a passive (e.g., without power and without use of an amplifier) circuit without a voltage input signal in which the variable termination circuit design of the passive CTLE 102 with an equalizing transmission coil improves the RX 108 bandwidth while improving circuit linearity and reduces the amount of surface area to implement in a semiconductor IC relative to conventional equalizers. The passive CTLE 102 avoids adding large amounts of high bandwidth AC gain to the RX 108, which increases PHY power and silicon area which increasing process, voltage, and temperature (PVT) variations. The passive component design of the passive CTLE 102 does not require tuning due to PVT variation, and provides an equalizing high-frequency boost without active power, thereby improving power-efficiency of transmitter-receiver operations. Thus, the CTLE 102 provides a boost to the high-frequency signal components of the input signal 110 and overcomes many of the ESD and bandwidth difficulties of traditional T-coil bridge topologies. That is, the passive CTLE 102 does not include a series inductor in the signal path and therefore does not incur a layout area penalty for a bridge T-coil, which requires a controlled design of the inductors equivalent series resistance (ESR). The passive CTLE 102 includes a shunt inductor DC resistance in series to the variable termination resistance, and ESR is therefore calibrated out. The passive CTLE 102 therefore improves signal quality and signal bandwidth of the eye diagram of the transmitted signal through the one or more channels 106, such as illustrated in FIG. 2.

One way to study ISI in a data transmission system is to apply a received wave to the vertical deflection plates of an oscilloscope and to apply a sawtooth wave at the transmitted symbol rate R, 1/T to the horizontal deflection plates. The resulting display is called an eye pattern because of its resemblance to the human eye for binary waves. The interior region of the eye pattern is called the eye opening. An eye pattern provides a information about the performance of the pertinent system, including but not limited to: 1. width of the eye opening defines the time interval over which the received wave can be sampled without error from ISI. It is apparent that the preferred time for sampling is the instant of time at which the eye is open widest; 2. sensitivity of the system to timing error is determined by the rate of closure of the eye as the sampling time is varied; and 3. height of the eye opening, at a specified sampling time, defines the margin over noise.

FIG. 2 is a diagram illustrating an eye diagram 200 at an output of the passive CTLE 102 (i.e., after equalization) according to some embodiments. The diagram illustrates a simulated eye diagram 200 produced by the equalized output signal 112 of a passive CTLE circuit, such as CTLE 102 of FIG. 1, for 32GT/s signaling with a required input eye input of 10 mV and 0.3UI. As illustrated, the eye diagram 200 for the passive CTLE 102 circuit exceeds the 10 mV minimum eye height by approximately 80% as well as the 0.3UI eye width requirement. Conventional CTLEs utilizing active power typically have eye openings half the size of that illustrated in eye diagram 200. Additional eye margin can be achieved with addition of a reduced positive gain amplifier (not shown). The passive CTLE 102 circuit has lower process, voltage and temperature (PVT) variation than an active circuit.

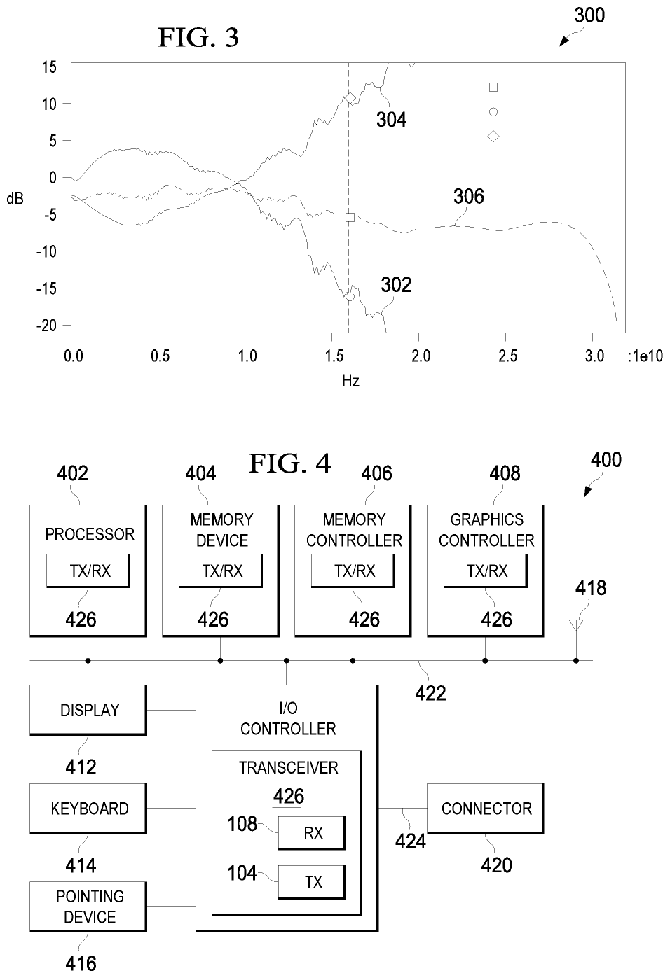

FIG. 3 is a diagram illustrating simulated frequency responses for a lossy channel cascaded with the passive CTLE 102 of FIG. 1 in accordance with some embodiments. As shown in plot 300, the channel frequency response 302 is close to zero or positive at low frequencies but drops off at higher frequencies. At frequencies close to Nyquist (e.g., approximately 16 GHz or one-half the data rate), the channel frequency response 302 is already substantially attenuated. The equalizer frequency response 304 (i.e., frequency domain response of the passive CTLE 102) is convolved with the channel frequency response 302 to generate the equalized frequency domain response 306 (i.e., frequency response of the output signal 112). As shown, the equalized frequency domain response 306 has a bandwidth that extends out from DC to Nyquist with roll-off that is moderate in that the attenuation is approximately −5 dB at 16 GHz, which is indicative of minimal signal distortion.

FIG. 4 is a block diagram illustrating a system 400 implementing the passive CTLE 102 of FIG. 1 in accordance with some embodiments. In various embodiments, the system 400 includes or is included in a computer, a tablet, or other electronic systems. As shown in FIG. 4, the system 400 include a processor 402, a memory device 404, a memory controller 406, a graphics controller 408, an input and output (I/O) controller 410, a display 412, a keyboard 414, a pointing device 416, at least one antenna 418, a connector 420, and a bus 422. In various embodiments, processor 402 includes a general-purpose processor or an application specific integrated circuit (ASIC). Each of the processor 402, the memory device 404, the memory controller 406, the graphics controller 408, and the I/O controller 410 can include an IC including passive CTLE 102 such as illustrated and described in more detail relative to FIG. 1.

In some arrangements, system 400 does not have to include a display. Thus, display 412 can be omitted from system 400. In some arrangements, system 400 does not have to include any antenna. Thus, antenna 418 can be omitted from system 400.

In various embodiments, memory device 404 includes a dynamic random access memory (DRAM) device, a static random access memory (SRAM) device, a flash memory device, or a combination of these memory devices. FIG. 4 shows an example where memory device 404 is a stand-alone memory device separated from processor 402. In an alternative embodiment, memory device 404 and processor 402 are located on the same die. In such an alternative embodiment, memory device 404 is an embedded memory in processor 402, such as embedded DRAM (eDRAM), embedded SRAM (eSRAM), embedded flash memory, or another type of embedded memory.

The display 412 includes a liquid crystal display (LCD), a touchscreen (e.g., capacitive or resistive touchscreen), or another type of display. The pointing device 416 includes a mouse, a stylus, or another type of pointing device. The I/O controller 410 includes a communication module for wired or wireless communication (e.g., communication through one or more antenna 418). Such wireless communication may include communication in accordance with WiFi communication technique, Long Term Evolution Advanced (LTE-A) communication technique, or other communication techniques. The I/O controller 410 also includes a module to allow system 400 to communicate with other devices or systems in accordance with to one or more of the following standards or specifications (e.g., I/O standards or specifications), including Universal Serial Bus (USB), DisplayPort (DP), High-Definition Multimedia Interface (HDMI), Thunderbolt, Peripheral Component Interconnect Express (PCIe), and other specifications.

The connector 420 can be arranged (e.g., can include terminals, such as pins) to allow system 400 to be coupled to an external device (or system). This allows system 400 to communicate (e.g., exchange information) with such a device (or system) through connector 420. The connector 420 may be coupled to I/O controller 410 through a connection 424 (e.g., a bus). The connector 420, connection 424, and at least a portion of bus 422 includes conductive lines that conform with at least one of USB, DP, HDMI, Thunderbolt, PCIe, and other specifications.

I/O controller 410 includes a transceiver (Tx/Rx) 426 having a transmitter (TX) 104 and a receiver (RX) 108. Transmitter 104 operates to transmit information from I/O controller 410 to another part of system 400 or to an external device (or system) coupled to connector 420. Receiver 108 operates to allow I/O controller 410 to receive information from another part of system 400 or from an external device (or system) coupled to connector 420. Receiver 108 can include any of the receivers described above with reference to FIG. 1 through FIG. 3.

As shown in FIG. 4, processor 402, memory device 404, memory controller 406, and graphics controller 408 include transceivers 426 to allow each of these components to transmit and receive information through their respective transceiver. In various embodiments, at least one of transceivers 426 includes include a receiver that is arranged to allow at least one of processor 402, memory device 404, memory controller 406, and graphics controller 408 to receive information (e.g., signals) from another part of system 400 or from an external device (or system) coupled to connector 420.

FIG. 4 shows the components of system 400 arranged separately from each other as an example. For example, each of processor 402, memory device 404, memory controller 406, graphics controller 408, and I/O controller 410 may be located on a separate die (e.g., semiconductor die or an IC chip). In some arrangements, two or more components (e.g., processor 402, memory device 404, graphics controller 408, and I/O controller 410) of system 400 is located on the same die (e.g., same IC chip) that forms a system-on-chip (SoC).

The apparatuses and syst described above can include or be included in high-speed computers, communication and signal processing circuitry, single-processor module or multi-processor modules, single embedded processors or multiple embedded processors, multi-core processors, message information switches, and application-specific modules including multilayer or multi-chip modules. Such apparatuses may further be included as sub-components within a variety of other apparatuses (e.g., electronic systems), such as televisions, cellular telephones, personal computers (e.g., laptop computers, desktop computers, handheld computers, etc.), tablets (e.g., tablet computers), workstations, radios, video players, audio players (e.g., MP3 (Motion Picture Experts Group, Audio Layer 3) players), vehicles, medical devices (e.g., heart monitors, blood pressure monitors, etc.), set top boxes, and others.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. An equalizer, comprising:
an alternating current (AC) coupling capacitor coupled in series between an input node and an output node of the equalizer;
an electrostatic discharge protection device coupled in parallel to the input node;
an inductor coupled in parallel to a node between the input node and the output node; and
a variable resistor coupled in series between the inductor and a ground.

2. The equalizer of claim 1, wherein an input signal that feeds into the input node is received from a communications channel.

3. The equalizer of claim 2, wherein increased impedance of the inductor at higher frequencies portions of the input signal operate to boost a gain of the equalizer at the higher frequencies.

4. The equalizer of claim 3, wherein the increased impedance of the inductor at higher frequencies is added in series to a termination value associated with the variable resistor to perform over-terminating of the input signal.

5. The equalizer of claim 2, wherein the equalizer further provides a positive direct current (DC) boost at lower portions of the input signal.

6. The equalizer of claim 2, wherein the equalizer comprises a passive continuous time linear equalizer (CTLE).

7. The equalizer of claim 6, wherein the CTLE provides an increase in gain to a high-frequency signal component of the input signal without a voltage input signal to the CTLE.

8. A system, comprising:
at least one processor;
at least one memory coupled to the at least one processor; and
an equalizer that facilitates communications among components in the system, wherein the equalizer includes:
an alternating current (AC) coupling capacitor coupled in series between an input node and an output node of the equalizer;
an electrostatic discharge protection device coupled in parallel to the input node;
an inductor coupled in parallel to a node between the input node and the output node; and
a variable resistor coupled in series between the inductor and a ground.

9. The system of claim 8, wherein an input signal that feeds into the input node is received from a communications channel.

10. The system of claim 9, wherein increased impedance of the inductor at higher frequencies portions of the input signal operate to boost a gain of the equalizer at the higher frequencies.

11. The system of claim 10, wherein the increased impedance of the inductor at higher frequencies is added in series to a termination value associated with the variable resistor to perform over-terminating of the input signal.

12. The system of claim 9, wherein the equalizer further provides a positive direct current (DC) boost at lower portions of the input signal.

13. The system of claim 9, wherein the equalizer comprises a passive continuous time linear equalizer (CTLE).

14. The system of claim 13, wherein the CTLE provides an increase in gain to a high-frequency signal component of the input signal without a voltage input signal to the CTLE.

15. The system of claim 13, wherein the CTLE provides an increase in gain to a high-frequency signal component of the input signal without attenuating lower-frequency signal components of the input signal.

16. An apparatus, comprising:
a receiver communicably coupled to a communications channel; and
a passive equalizer of the receiver configured to receive an input signal from the communications channel and generate an equalized output signal, wherein the passive equalizer comprises:
an alternating current (AC) coupling capacitor coupled in series between an input node and an output node of the passive equalizer;
an electrostatic discharge protection device coupled in parallel to the input node;
an inductor coupled in parallel to a node between the input node and the output node; and
a variable resistor coupled in series between the inductor and a ground.

17. The apparatus of claim 16, wherein increased impedance of the inductor at higher frequencies portions of the input signal operate to boost a gain of the passive equalizer at the higher frequencies.

18. The apparatus of claim 17, wherein the increased impedance of the inductor at higher frequencies is added in series to a termination value associated with the variable resistor to perform over-terminating of the input signal.

19. The apparatus of claim 16, wherein the passive equalizer comprises a passive continuous time linear equalizer (CTLE).

20. The apparatus of claim 19, wherein the CTLE provides an increase in gain to a high-frequency signal component of the input signal without a voltage input signal to the CTLE.
